(19) United States
(12) Patent Application Publication
(10) Pub. No.: US 2018/0110098 A1
(43) Pub. Date: Apr. 19, 2018

(54) HIGH-FREQUENCY DIELECTRIC HEATING DEVICE

(71) Applicant: TOYO SEIKAN GROUP HOLDINGS, LTD., Tokyo (JP)

(72) Inventors: Tomoki Maruyama, Yokohama-shi (JP); Shinji Yamada, Yokohama-shi (JP)

(73) Assignee: TOYO SEIKAN GROUP HOLDINGS, LTD., Tokyo (JP)

(21) Appl. No.: 15/844,824

(22) Filed: Dec. 18, 2017

Related U.S. Application Data
(63) Continuation of application No. PCT/JP2016/066624, filed on Jun. 3, 2016.

(30) Foreign Application Priority Data
Jul. 3, 2015 (JP) 2015-134646
Jul. 3, 2015 (JP) 2015-134647
Jun. 3, 2016 (JP) 2016-111797
Jun. 3, 2016 (JP) 2016-111798

(51) Int. Cl. H05B 6/50; H05B 6/54

(52) U.S. Cl. CPC H05B 6/50; H05B 6/54

(57) ABSTRACT

Provided is a high-frequency dielectric heating device in which fine impedance adjustment can be achieved easily and with high precision while reducing a device cost and simplifying a device structure. A high-frequency dielectric heating device (10) includes a high-frequency power supply (20), a pair of electrodes (30) disposed opposite each other, reflected power detector 60 connected between the electrodes (30) and the high-frequency power supply (20) and detects reflected power generated when a heating subject is heated, and an impedance matching device (40) that adjusts the reflected power, wherein the matching device (40) includes a capacitor (C1) connected in parallel to the high-frequency power supply (20), and at least one of a capacitor (C2) and a coil (L) connected in series to the electrodes (30), at least a reactance of the capacitor or the coil being adjustable, and the high-frequency power supply (20) is configured to have a variable frequency.

### TECHNICAL FIELD

The present invention relates to a high-frequency dielectric heating device for heating a heating subject disposed between opposing electrodes by means of high-frequency dielectric heating, and more particularly to a high-frequency dielectric heating device for thawing a frozen foodstuff by means of high-frequency dielectric heating.

### BACKGROUND ART

A high-frequency dielectric heating device that heats a heating subject disposed between opposing electrodes by means of high-frequency dielectric heating is available as a conventional high-frequency dielectric heating device for heating a heating subject by means of high-frequency dielectric heating (see Patent Literature 1, for example). High-frequency dielectric heating is a heating method in which a high-frequency voltage is applied to the heating subject (a dielectric) in order to vary respective polarities of molecules constituting the heating subject at a high frequency, and the heating subject is heated by internal heat build-up caused by rotation, collision, oscillation, friction, and so on of the molecules as the polarities thereof are varied.

An electrode impedance when the heating subject is placed varies greatly according to a shape, a type, and a heating or thawing temperature of the heating subject. At this time, in a state where a difference exists between an output impedance of a high-frequency power supply and the electrode impedance when the heating subject is placed, or in other words when impedance matching has not been achieved, reflected power may be generated, leading to a reduction in heating or thawing efficiency, and as a result, a circuit element may break or deteriorate.

To avoid this, an impedance match is maintained by inserting a matching device between the high-frequency power supply and the electrodes and providing a capacitor and a coil, for example, as constituent elements thereof.

A vacuum tube type high-frequency power supply, which has a simple structure, includes circuit elements with high heat-resistance temperatures, and exhibits superior resistance to reflected power, is typically used to heat or thaw a heating subject such as a foodstuff, with which the electrode impedance varies greatly according to the shape, type, and heating or thawing temperature of the foodstuff or the like. However, a vacuum tube type high-frequency power supply, due to a power amplification characteristic thereof, is large, has a high anode voltage, exhibits poor power supply efficiency, and has a high device cost due to the need to compensate for these problems by means of an increase in output. Moreover, a filament must be preheated, meaning that it takes time to start the device. Furthermore, a resonance frequency thereof varies unpredictably depending on the electrode impedance when the heating subject is placed. More specifically, the power supply frequency affects a uniformity (power penetration depth) with which foodstuffs of various shapes are heated or thawed, and therefore, in certain conditions, the resonance frequency varies unpredictably, which is undesirable. It is also preferable to ensure that the power supply frequency remains within a predetermined frequency variation width in order to comply with frequency provisions of the radio law.

On the other hand, by combining a semiconductor type high-frequency power supply that performs power amplification by executing high-speed switching control on a semiconductor with a high-resolution automatic matching device, a small, highly efficient system is obtained, and this type of system is used conventionally in applications such as plasma discharge.

A state of matching impedance is maintained by successively varying a value of a variable capacitor or a variable coil serving as a constituent element of the matching device, but in the case of a large-capacity load such as a foodstuff, with which the electrode impedance varies greatly depending on the shape, type, and temperature thereof, the capacitor or coil must be provided with a large impedance adjustment width in order to maintain the matching state, and as a result, the matching device increases in size and cost.

Further, an inverted L type circuit shown in FIG. 10A or a π type circuit shown in FIG. 10B may be used as a circuit configuration of an automatic matching device used for plasma discharge.

FIG. 10A shows a configuration including a first capacitor C1 connected in parallel to a high-frequency power supply 20, and a second capacitor C2 and a coil L connected in series to electrodes 30, wherein the first capacitor C1 and the second capacitor C2 have variable capacitances, and impedance matching is achieved by varying values thereof successively in real time.

Here, when a combined impedance of the output impedance of the high-frequency power supply 20 and the matching device 40 is set as Z,

Z=R/(1+ω²R²C₁²)+j{(ωL−1/ωC₂)−ωR²C₁/(1+ω²R²C₁²)},

a complex conjugate Z′ of which is given as an impedance matching range of the variable capacitance capacitors C1, C2. At this time, a resistance R/(1+ω²R²C₁²) of Z′ does not increase beyond the output impedance R of the power supply, and therefore impedance matching cannot be achieved appropriately in relation to a load having a large resistance or impedance, such as a foodstuff, for example.

Here, the respective symbols in the formula are as follows.

ω: angular frequency

R: output impedance of power supply

L: reactance of coil

C₁: capacitance of variable capacitance first capacitor

C₂: capacitance of variable capacitance second capacitor

FIG. 10B shows a configuration including the first capacitor C1 connected in parallel to the high-frequency power supply 20, a third capacitor C3 connected in parallel to the electrodes 30, and the coil L connected in series between the first capacitor C1 and the third capacitor C3, wherein the first capacitor C1 and the third capacitor C3 have variable capacitances, and impedance matching is achieved by varying values thereof in real time.

However, in a configuration where the third capacitor C3 has a variable capacitance and the value thereof is varied successively, the electrode impedance also varies successively in accordance therewith, and therefore, particularly in a case where a large-capacity load such as a foodstuff is disposed between the electrodes 30 and the electrode impedance varies greatly depending on the shape, type, and heating or thawing temperature thereof, capacitance variation is promoted, making it difficult to perform impedance matching continuously with stability. To maintain an impedance match in a state where the electrode impedance is unstable, the first capacitor C1 must be provided with a large impedance adjustment width, leading to increases in the size and cost of the matching device 40.

### CITATION LIST

### Patent Literature

Patent Literature 1: Japanese Patent Application Publication No. H08-255682

Patent Literature 2: Japanese Patent Application Publication No. 2005-56781

### SUMMARY OF INVENTION

### Technical Problem

A high-frequency dielectric heating device in which a matching circuit includes a variable coil and a capacitor, and a capacitance of the capacitor can be increased by switching means is available as a high-frequency dielectric heating device for avoiding the problem of an increase in the size of the matching device (see Patent Literature 2, for example).

In the high-frequency dielectric heating device described in Patent Literature 2, impedance matching is achieved such that reflected power is kept at a minimum by detecting power reflected to a high-frequency power supply using reflected power detector, and combining respective values of the variable coil and the capacitor appropriately on the basis of a detection signal from the reflected power detector.

In the high-frequency dielectric heating device described in Patent Literature 2, impedance adjustment is achieved by varying the capacitances of the capacitor and the coil, but in a case where the impedance variation is large, which occurs particularly when thawing a foodstuff, the impedance adjustment widths of the coil and the capacitor must again be increased, and therefore the size of the matching device cannot be reduced.

Hence, in the present invention, to solve these problems, an oscillation efficiency of a high-frequency power supply is improved by performing impedance matching successively in response to variation in an electrode impedance corresponding to a shape, a type, a heating or thawing temperature, and so on of a foodstuff, and in so doing, a power supply can be reduced in size. Further, an impedance adjustment function is realized by configuring a power supply frequency to be variable within a predetermined range, and in so doing, a matching device can be simplified and reduced in size. Accordingly, an object of the present invention is to provide a small, inexpensive high-frequency dielectric heating device that can perform high-quality heating or thawing on various foodstuffs.

A further object of the present invention is to provide a small, inexpensive high-frequency dielectric heating device capable of high-quality heating or thawing, in which a small, highly efficient semiconductor type high-frequency power supply is used to heat or thaw a foodstuff, and electrode impedance variation is suppressed even in a situation where the electrode impedance varies easily in accordance with the shape, type, and heating or thawing temperature of the foodstuff, with the result that impedance matching can be achieved favorably while simplifying a matching device and reducing the size thereof.

### Solution to Problem

An aspect of the present invention solves the problems described above by providing a high-frequency dielectric heating device including a high-frequency power supply, a pair of electrodes disposed opposite each other, reflected power detector connected between the electrodes and the high-frequency power supply and detects reflected power generated when a heating subject is heated, and an impedance matching device that adjusts the reflected power, wherein the matching device includes a capacitor connected in parallel to the high-frequency power supply, and at least one of a capacitor and a coil connected in series to the electrodes, at least a reactance of the capacitor or the coil being adjustable, and the high-frequency power supply is configured to have a variable frequency.

Another aspect of the present invention solves the problems described above by providing a high-frequency dielectric heating device including a semiconductor type high-frequency power supply, a pair of electrodes disposed opposite each other, and an impedance matching device, wherein the matching device includes a first capacitor connected in parallel to the high-frequency power supply, a third capacitor connected in parallel to the electrodes, and a coil and a second capacitor connected in series between the first capacitor and the third capacitor.

### Advantageous Effects of Invention

According to one aspect of the present invention, an oscillation efficiency of the high-frequency power supply is improved by detecting the reflected power generated when the heating subject is heated or thawed using the reflected power detector, and performing impedance matching successively, and as a result, the power supply can be reduced in size. Further, the impedance matching device includes the capacitor connected in parallel to the high-frequency power supply and at least one of the capacitor and the coil connected in series to the electrodes, at least the reactance of the capacitor or the coil being adjustable, and the high-frequency power supply is configured to have a variable frequency. Hence, by varying the frequency of the power supply, the reactance of at least one of the capacitor and the coil connected in series to the electrodes can be adjusted at a high resolution, and as a result, impedance adjustment can be achieved easily and with high precision while simplifying the matching device and reducing the size thereof.

According to another aspect of the present invention, by employing a semiconductor type high-frequency power supply as the high-frequency power supply, highly responsive impedance matching can be performed while obtaining effects such as high efficiency, reduced size and weight, and low cost, and therefore damage to the power supply can be suppressed cleverly and favorably.

According to another aspect of the present invention, by providing the matching device with the varier that implements either multistep switching or continuous variation on the capacitance of at least one of the capacitor connected in parallel to the high-frequency power supply and the capacitor connected in series to the electrodes, a reactance adjustment width obtained by varying the frequency of the power supply can be set in the vicinity of an electrode impedance such that the reflected power can be suppressed more quickly by means of impedance matching. Furthermore, a frequency variation width of the high-frequency power supply can be set at a small width, and therefore the quality with which a foodstuff is heated or thawed can be maintained at a favorable level at all times, even when the matching device is simplified and reduced in size.

According to another aspect of the present invention, by providing the matching device with the capacitor connected in parallel to the electrodes, a rate at which the electrode impedance varies during heating or thawing can be reduced. As a result, the frequency variation width of the high-frequency power supply can be set at a small width, and therefore the quality with which a foodstuff is heated or thawed can be maintained at a favorable level at all times, even when the matching device is simplified and reduced in size.

This is particularly effective in a case where the rate at which the electrode impedance varies during thawing is large, for example a case in which the electrodes contact or follow the shape of the foodstuff or foodstuff packaging with the aim of executing high-efficiency thawing.

According to another aspect of the present invention, by providing the small, highly efficient semiconductor type high-frequency power supply and the third capacitor connected in parallel to the electrodes, a foodstuff can be heated or thawed with stability while suppressing variation in the electrode impedance.

According to another aspect of the present invention, the capacitance of the capacitor can be adjusted by the capacitance varier provided in at least one of the first capacitor and the second capacitor, and therefore impedance matching can be realized favorably in relation to various foodstuffs having different shapes, types, and electrical characteristics.

According to another aspect of the present invention, at least the resistance of the impedance matching range formed by the output impedance of the high-frequency power supply and the matching device includes a part that is larger than the output impedance, while the reactance range is set to be larger on a negative side than on a positive side, and this configuration can be realized easily by setting the third capacitor at a predetermined value.

Hence, the impedance matching range can be specialized for foodstuff thawing, and as a result, the matching device can be simplified and reduced in size. Moreover, an impedance matching time can be shortened such that the reflected power is prevented from causing damage to and deterioration of devices, and as a result, an improvement in reliability can be achieved.

According to another aspect of the present invention, accurate information relating to the foodstuff impedance can be obtained easily from the impedance information output controller of the matching device. Therefore, parameters of the matching device can be set specifically for the heating subject, and the matching device can be simplified on the basis of the results.

### BRIEF DESCRIPTION OF DRAWINGS

FIG. 1 is a circuit diagram showing a high-frequency dielectric heating device according to a first embodiment of the present invention.

FIG. 2A is a table showing an amount of variation in a second capacitor when a third capacitor is not provided.

FIG. 2B is a table showing an amount of variation in a second capacitor when a third capacitor is provided.

FIG. 3 is a graph showing measurement results obtained in a first experimental example in relation to a frequency and a reflectance.

FIG. 4A is a circuit diagram showing a high-frequency dielectric heating device according to a second embodiment of the present invention.

FIG. 4B is a circuit diagram showing a high-frequency dielectric heating device according to a second embodiment of the present invention.

FIG. 5 is a table showing variation in a capacitance of a first capacitor when the third capacitor is and is not provided.

FIG. 6 is an illustrative view showing an impedance matching range of a circuit configuration shown in FIGS. 10A and B.

FIG. 7A is an illustrative view showing the impedance matching range of a circuit configuration shown in FIGS. 4A and B.

FIG. 7B is an illustrative view showing the impedance matching range of a circuit configuration shown in FIGS. 4A and B.

FIG. 7C is an illustrative view showing the impedance matching range of a circuit configuration shown in FIGS. 4A and B.

FIG. 7D is an illustrative view showing the impedance matching range of a circuit configuration shown in FIGS. 4A and B.

FIG. 8 is a table showing results obtained by measuring variation in the respective capacitances of the first capacitor and the second capacitor.

FIG. 9 is a table showing results obtained by measuring variation in the respective capacitances of the first capacitor and the second capacitor under different conditions to FIG. 8.

FIG. 10A is a circuit diagram showing reference examples of circuit configurations of an automatic matching device applied to plasma discharge.

FIG. 10B is a circuit diagram showing reference examples of circuit configurations of an automatic matching device applied to plasma discharge.

### REFERENCE SIGNS LIST

10 High-frequency dielectric heating device

20 High-frequency power supply

30 Electrode

40 Matching device

50 Reactance circuit

60 reflected power detector

70 impedance information output controller

C1 First capacitor

C2 Second capacitor

C3 Third capacitor

L Coil

### DESCRIPTION OF EMBODIMENT

A high-frequency dielectric heating device 10 according to a first embodiment of the present invention will be described below on the basis of the figures.

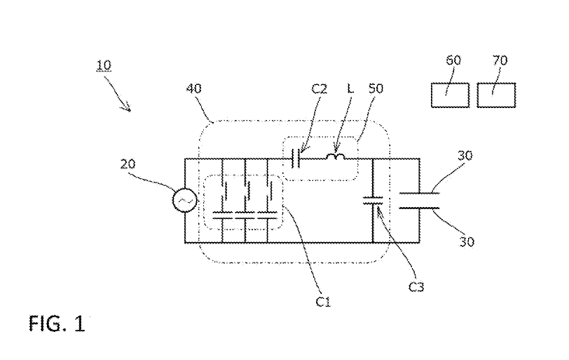

As shown in FIG. 1, the high-frequency dielectric heating device 10 includes a high-frequency power supply 20, a pair of electrodes 30, a matching device 40 connected between the high-frequency power supply 20 and the electrodes 30 to achieve impedance matching with the high-frequency power supply 20, a reflected power detector 60 as reflected power detecting means that detects power reflected to the high-frequency power supply 20, and a control unit (not shown) that controls the respective parts, and is used to thaw a frozen foodstuff disposed between the pair of mutually opposed electrodes 30 by means of high-frequency dielectric heating.

The high-frequency power supply 20 is constituted by a variable frequency semiconductor type high-frequency power supply having a variable frequency. Further, the high-frequency power supply 20 is configured such that a high-frequency output thereof is suppressed or stopped by a protective function when a reflectance detected by the reflected power detector 60 exceeds a predetermined threshold.

As shown in FIG. 1, the matching device 40 includes a reactance circuit 50 connected in series to the electrodes 30, a first capacitor C1 connected in parallel to the electrodes 30 between the reactance circuit 50 and the high-frequency power supply 20, and a third capacitor C3 connected in parallel to the electrodes 30 between the electrodes 30 and the reactance circuit 50.

The reactance circuit 50 includes at least one reactance element connected in series to the electrodes 30, and in the first embodiment, as shown in FIG. 1, includes a second capacitor C2 and a coil L connected in series to the high-frequency power supply 20.

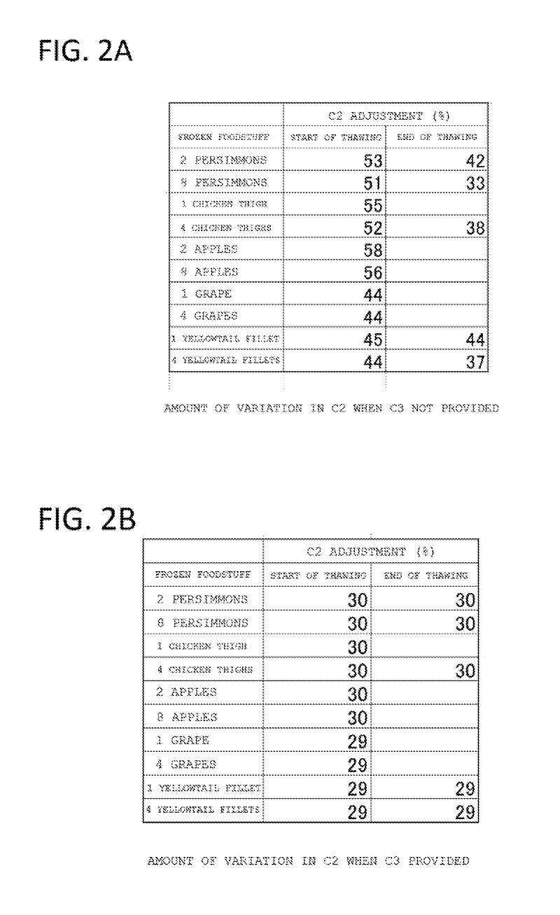

FIGS. 2A and B shows values (capacitance %) obtained when a frequency of the high-frequency power supply was set at 13.56 MHz, a capacitance of the first capacitor C1 was set at 1500 pF, an inductance of the coil L was set at 1.8 μH, and various foodstuffs were thawed while adjusting a capacitance of the second capacitor C2 so that the reflected power detected by the reflected power detector 60 was at a minimum at all times.

As is evident from FIGS. 2A and B, when the third capacitor C3 is not disposed, the capacitance % of the second capacitor C2 at the start of thawing varies according to the type and number of the foodstuff, while at the end of thawing, the capacitance % of the second capacitor C2 varies greatly in a decreasing direction.

When the third capacitor C3 is disposed, the variation in the capacitance % of the second capacitor C2 corresponding to the type and number of the foodstuff is small at both the start of thawing and the end of thawing. It is evident from these results that by disposing the third capacitor C3, the rate at which an electrode impedance varies while thawing a foodstuff can be reduced, and as a result, a frequency variation width of the high-frequency power supply 20 can be set at a small width.

The matching device 40 includes varier as varying means constituted by a relay or other contact means, a variable capacitor, or the like and implements either multistep switching or continuous variation on the capacitance of the first capacitor C1 connected in parallel to the high-frequency power supply 20.

Note that the specific form of the varier is not limited to those described above, and any means capable of implementing either multistep switching or continuous variation on the capacitance of the first capacitor C1 may be used. The varier may also implement multistep switching or continuous variation on the capacitance of the capacitor connected in series to the electrodes 30.

The control unit is designed to achieve impedance matching by switching the capacitance of the first capacitor C1 in the decreasing direction and adjusting the frequency of the high-frequency power supply 20 in accordance with the thawed state of the heating subject on the basis of the reflectance detected by the reflected power detector 60.

### FIRST EXAMPLE

A first experimental example of the present invention will now be described.

In the first experimental example, the capacitance of the second capacitor C2 of the reactance circuit 50 was set at 93 pF, the inductance of the coil L was set at 1.8 μH, and impedance adjustment was implemented on the reactance circuit 50 by adjusting the frequency of the high-frequency power supply 20. Further, the capacitance of the third capacitor C3 was set at 400 pF. Furthermore, the high-frequency power supply 20 was configured such that the high-frequency output thereof was stopped by the protective function when the reflectance detected by the reflected power detector 60 exceeded 40%. Moreover, frozen persimmons (four) were used as the thawing subject (heating subject) disposed between the pair of electrodes 30.

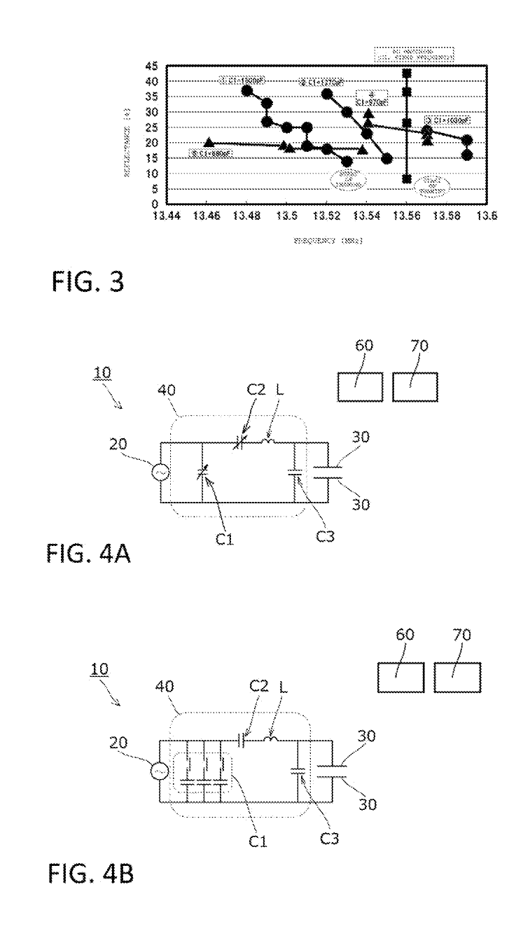

FIG. 3 shows results obtained by measuring the frequency and the reflectance every minute following the start of thawing.

When thawing was executed with the capacitance of the first capacitor C1 set at 1500 pF and the frequency of the high-frequency power supply 20 fixed at 13.56 MHz, i.e. when impedance match adjustment was not performed during thawing, the reflectance exceeded the threshold (40%) after approximately three minutes. High-frequency oscillation by the high-frequency power supply 20 was then stopped, and the thawing was interrupted.

Further, in a case where impedance adjustment was executed on the reactance circuit 50 by switching the capacitance of the first capacitor C1 and adjusting the frequency of the high-frequency power supply 20, when thawing was started after setting the capacitance of the first capacitor C1 at 1500 pF, the time required for the reflectance to reach the threshold (40%) was extended to seven minutes by varying the frequency (13.53 MHz→13.48 MHz) during the thawing, and as a result, it was possible to lengthen the time taken by the reflectance to reach the threshold in comparison with a case in which frequency adjustment was not performed.

By switching the capacitance of the first capacitor C1 to 1270 pF at the point where the reflectance reached the threshold, the reflectance was reduced by approximately 15%, and at the same time, the frequency changed (13.48 MHz→13.55 MHz) so as to recover substantially to the frequency at the start of thawing, i.e. 13.53 MHz. Similarly, by switching the capacitance of the first capacitor C1 as appropriate in the decreasing direction to 1030 pF, 970 pF, and 880 pF in accordance with the reflectance, it was possible to apply a high frequency while keeping the reflectance at or below the threshold, and as a result, thawing was completed.

It was confirmed from the above that with the high-frequency dielectric heating device 10, impedance adjustment can be implemented on the reactance circuit 50 by variably adjusting the frequency of the high-frequency power supply 20, and impedance matching can be achieved inexpensively by the matching device 40 implementing multistep switching using a relay or the like. Furthermore, by employing variable capacitors in the matching device 40 to implement capacitor capacitance adjustment, impedance adjustment can be achieved easily with a higher degree of precision. Moreover, by additionally implementing capacitor capacitance adjustment using the matching device 40 while variably adjusting the frequency of the hiqh-frequency power supply 20, a frequency variation width can be reduced.

Next, the high-frequency dielectric heating device 10 according to a second embodiment of the present invention will be described on the basis of the figures.

As shown in FIGS. 4A and B, the high-frequency dielectric heating device 10 includes the semiconductor type high-frequency power supply 20, the pair of electrodes 30, the matching device 40 connected between the high-frequency power supply 20 and the electrodes 30 to achieve impedance matching, a coaxial cable (not shown) that connects the high-frequency power supply 20 to the matching device 40, the reflected power detector 60 as reflected power detecting means that detects the power reflected to the high-frequency power supply 20, and the control unit (not shown) that controls the respective parts, and is used to thaw a frozen foodstuff disposed between the pair of mutually opposed electrodes 30 by means of high-frequency dielectric heating. Note that the high-frequency power supply 20 is configured such that the high-frequency output thereof is suppressed or stopped by the protective function when the reflectance detected by the reflected power detector 60 exceeds the predetermined threshold.

As shown in FIGS. 4A and B, the matching device 40 includes the first capacitor C1 connected in parallel to the high-frequency power supply 20, the third capacitor C3 connected in parallel to the electrodes 30, and the coil L and the second capacitor C2 connected in series between the first capacitor C1 and the third capacitor C3, and by connecting the third capacitor C3 in parallel to the electrodes 30 in the interior of the matching device 40, a circuit configuration for suppressing variation in the electrode impedance is realized.

At least one of the first capacitor C1 and the second capacitor C2 includes capacitance varier as capacitance varying means so that capacitance adjustment can be implemented thereon in order to suppress the reflected power detected by the reflected power detector 60 during thawing. Capacitance adjustment may be implemented on the capacitor using a continuous adjustment method realized by driving a variable capacitor, as shown in FIG. 4A, or a multistep switching method realized by a relay, as shown in FIG. 4B. Further, although the capacitance of the third capacitor C3 is not subjected to variable adjustment successively during thawing, the capacitance thereof is set in advance at an optimum value corresponding to the load, and for this purpose, the third capacitor C3 may include a simple capacitance variation mechanism.

In the circuit configuration shown in FIGS. 4A and B, when the combined impedance of the output impedance of the high-frequency power supply 20 and the matching device 40 is set as Z, the combined impedance Z is expressed by the following formula.

Z=1/[{(1/R+jωC₁)⁻¹+j(ωL−1/ωC₂)}⁻¹+jωC₃]

The respective symbols in the formula are as follows.

ω: angular frequency

R: output impedance of power supply (resistance of coaxial cable)

L: reactance of coil

C₁: capacitance of variable capacitance first capacitor

C₂: capacitance of variable capacitance second capacitor

C₃: capacitance of third capacitor

Here, when the complex conjugate of the combined impedance Z is set as Z′, a range of Z′ obtained at the capacitance variation width of the first capacitor C1 or the second capacitor C2 corresponds to the impedance matching range, and can be set freely in accordance with the respective values of ω, R, L, C₁, C₂, and C₃.

By setting the third capacitor C3 at a predetermined value, at least the resistance of the impedance matching range formed by the output impedance of the high-frequency power supply 20 and the matching device 40 becomes larger than the output impedance (includes a part that is larger than the output impedance), while the range of the reactance becomes larger on a negative side than on a positive side.

The control unit is designed to achieve impedance matching by switching the capacitance of at least one of the first capacitor C1 and the second capacitor C2 in the decreasing direction in accordance with the thawed state of the heating subject on the basis of the reflectance detected by the reflected power detector 60. The control unit does not variably adjust the capacitance of the third capacitor C3 during thawing.

### SECOND EXAMPLE

A second experimental example of the present invention will now be described.

FIG. 2A shows values (capacitance %) obtained when the frequency of the high-frequency power supply 20=13.56 MHz, the output impedance of the high-frequency power supply 20=50Ω, the capacitance C₁ of the first capacitor C1=1500 pF, the capacitance C₂ of the variable capacitance second capacitor C2=25 to 250 pF, the inductance L of the coil L=1.8 μH, and various foodstuffs were thawed while adjusting the capacitance of the second capacitor C2 so that the reflected power detected by the reflected power detector 60 was at a minimum at all times.

When the third capacitor C3 is not connected, the C2 capacitance % at the start of thawing differs depending on the type and number of the foodstuff, while the C2 capacitance % at the end of thawing varies greatly in the decreasing direction. In other words, it is difficult to implement impedance matching without increasing the capacitance variation width of the second capacitor C2, and as a result, the matching device 40 cannot be simplified and reduced in size.

FIG. 2B shows values (capacitance %) obtained when, in addition to the circuit configuration described above, the third capacitor C3 having a capacitance of 400 pF was connected in parallel to the electrodes 30, and various foodstuffs were thawed while adjusting the capacitance of the second capacitor C2 so that the reflected power detected by the reflected power detector 60 was at a minimum at all times. The various foodstuffs can be thawed without greatly varying the capacitance % of the second capacitor C2, and therefore the matching device 40, in which the capacitance variation width of the second capacitor C2 is reduced, can be simplified and reduced in size.

FIG. 5 shows values (capacitance %) of C1 obtained when the frequency of the high-frequency power supply 20=13.56 MHz, the output impedance of the high-frequency power supply 20=50Ω, the capacitance C₂ of the second capacitor C2=95 pF, the inductance L of the coil L=1.8 μH, the capacitance C₁ of the variable capacitance first capacitor C1=150 to 1500 pF, the capacitance C₃ of the third capacitor C3=400 pF, and various foodstuffs were thawed while adjusting the capacitance of the first capacitor C1 so that the reflected power detected by the reflected power detector 60 was at a minimum at all times. By connecting the third capacitor C3, the capacitance variation width of the first capacitor C1 can be set at a small width, and as a result, the matching device 40 can be simplified and reduced in size.

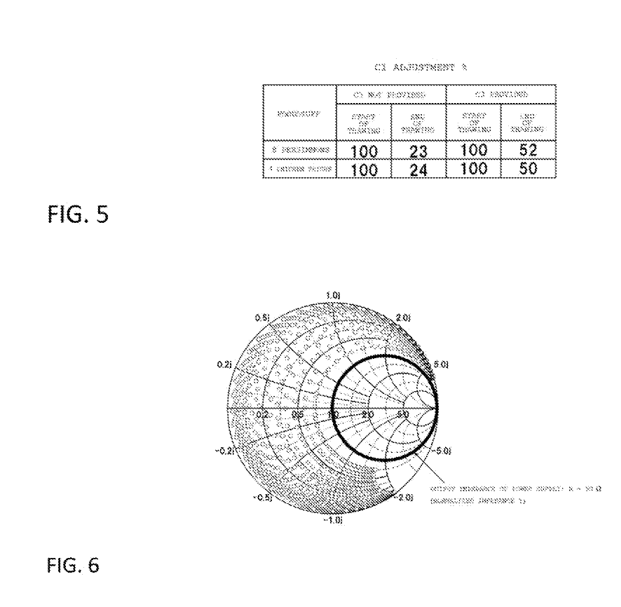

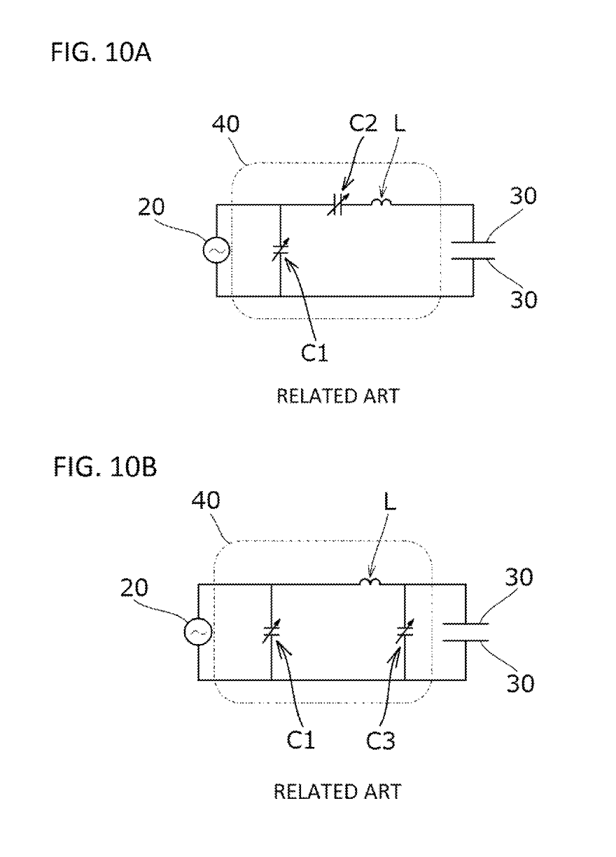

FIG. 6 shows an impedance matching range obtained with the circuit configuration shown in FIG. 10A at the complex conjugate Z′ of Z=R/(1+ω²R²C₁²)+j{(ωL−1/ωC₂)−ωR²C₁/(1+ω²R²C₁²)}, where Z denotes the combined impedance of the high-frequency power supply 20 and the matching device 40.

Here, the angular frequency ω=13.56 MHz, the output impedance R of the high-frequency power supply 20=50Ω, the reactance L of the coil L=1.8 μH, the capacitance C₁ of the variable capacitance first capacitor C1=150 to 1500 pF, and the capacitance C₂ of the variable capacitance second capacitor C2=25 to 250 pF.

The impedance matching range obtained at Z′ was limited to a smaller range than the output impedance R=50Ω (a normalized impedance 1) of the high-frequency power supply 20, and as a result, impedance matching could not be implemented on a larger resistance load than the impedance matching range.

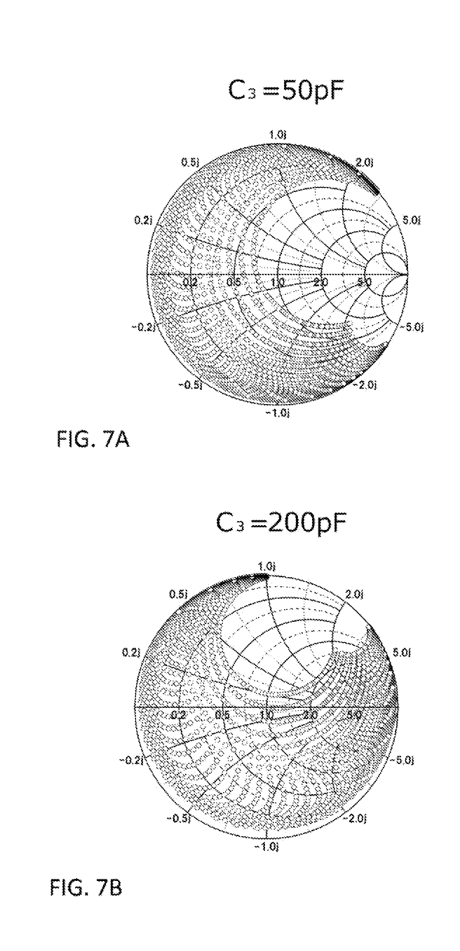

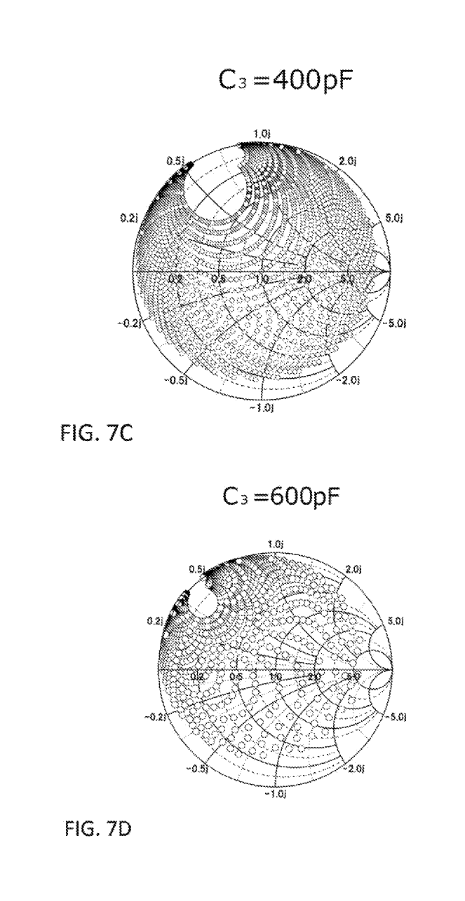

FIGS. 7A to D shows an impedance matching range obtained with the circuit configuration shown in FIGS. 4A and B at the complex conjugate Z′ of Z=1/[{(1/R+jωC₁)⁻¹+j(ωL−1/ωC₂)}⁻¹+jωC₃], where Z denotes the combined impedance of the output impedance of the high-frequency power supply 20 and the matching device 40.

Here, the angular frequency ω=13.56 MHz, the output impedance R of the power supply=50Ω, the reactance L of the coil L=1.8 μH, the capacitance C₁ of the variable capacitance first capacitor C1=150 to 1500 pF, the capacitance C₂ of the variable capacitance second capacitor C2=25 to 250 pF, and the capacitance C₃ of the third capacitor C3=50 pF, 200 pF, 400 pF, and 600 pF.

By connecting the third capacitor C3 in parallel to the electrodes 30 and increasing the value thereof, the impedance matching range obtained at Z′ in the example shown in FIG. 6 was rotated counterclockwise such that the resistance of Z′ was enlarged to a larger range than the output impedance R=50Ω (the normalized impedance 1) of the power supply. The range of the reactance was larger on the negative side than on the positive side when the capacitance C₃ of the third capacitor C3=200 pF and 400 pF, and was smaller on the negative side than on the positive side when C₃=600 pF. Hence, by connecting the third capacitor C3 in parallel to the electrodes 30, a specialized matching range for thawing a frozen foodstuff can be obtained.

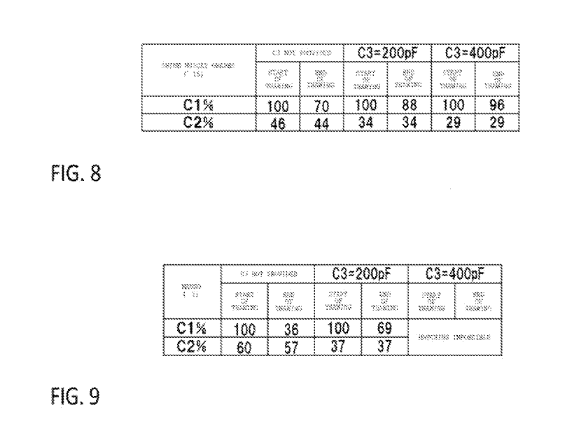

FIG. 8 shows values (capacitance %) of C1 and C₂, obtained when the frequency of the high-frequency power supply 20=13.56 MHz, the output impedance of the high-frequency power supply 20=50Ω, the inductance L of the coil L=1.8 μH, the capacitance C₁ of the variable first capacitor C1=150 to 1500 pF, the capacitance C₂ of the variable second capacitor C2=25 to 250 pF, the capacitance C₃ of the third capacitor C3=200 pF and 400 pF, and 15 Shine Muscat grapes (thickness 28 mm) frozen to −40° C. were thawed for a thawing time of 15 minutes at an output of 50 W while successively adjusting the respective capacitances of the variable capacitors C1 and C2 automatically using a servo motor so that the reflected power detected by the reflected power detector 60 was at a minimum at all times.

In a state where the third capacitor C3 was not connected, the respective values of the variable capacitors C1 and C2 varied greatly in the decreasing direction during thawing, but by connecting the third capacitor C3, the variation in the variable capacitors C1 and C2 was suppressed, the variation suppression effect obtained in relation to the variable capacitors C1 and C2 being greater when C₃=400 pF than when C₃=200 pF.

FIG. 9 shows values (capacitance %) of C₁ and C₂, obtained when the frequency of the high-frequency power supply 20=13.56 MHz, the output impedance of the high-frequency power supply 20=50Ω, the inductance L of the coil L=1.8 μH, the capacitance C₁ of the variable first capacitor C1=150 to 1500 pF, the capacitance C₂ of the variable second capacitor C2=25 to 250 pF, the capacitance C₃ of the third capacitor C3=200 pF and 400 pF, and a frozen mango (thickness 85 mm) frozen to −40° C. was thawed for a thawing time of 15 minutes at an output of 200 W while successively adjusting the respective capacitor capacitances of the variable capacitors C1 and C2 automatically using a servomotor so that the reflected power detected by the reflected power detector 60 was at a minimum at all times.

In a state where the third capacitor C3 was not connected, the respective values of the variable capacitors C1 and C2 varied greatly in the decreasing direction during thawing, whereas in a state where the third capacitor C3 was connected at C₃=200 pF, the variation in the variable capacitors C1 and C2 was suppressed. In a state where the third capacitor C3 was connected at C₃=400 pF, automatic impedance matching was not possible.

Hence, it was confirmed that in the high-frequency dielectric heating device 10, by connecting the third capacitor C3 in parallel to the electrodes 30 in the matching device 40, variation in the electrode impedance as a foodstuff is thawed can be suppressed, and as a result, impedance matching can be achieved while simplifying the matching device 40 and reducing the size thereof.

At this time, variation in the electrode impedance is suppressed more effectively when the value of the capacitor capacitance of the third capacitor C3 is large, but in the case of a thick frozen foodstuff, matching may be difficult, and therefore an optimum value of C3 is preferably set in accordance with the foodstuff.

Embodiments of the present invention were described in detail above, but the present invention is not limited to the above embodiments, and various design modifications may be applied thereto without departing from the invention described in the claims.

For example, in the above embodiments, the high-frequency dielectric heating device is used to thaw a frozen foodstuff by means of high-frequency dielectric heating, but a similar effect can be obtained when thawing a material other than a foodstuff, for example blood or an organism such as an animal or a plant. Further, the high-frequency dielectric heating device is not limited to an application in which a frozen foodstuff is thawed, and may be used to heat another heating subject.

Furthermore, in addition to the above embodiments, an impedance information output controller 70 that outputs impedance information (the state of the first capacitor, for example) relating to the matching device to a monitoring monitor or the like may be provided. In this case, accurate information relating to the foodstuff impedance can be obtained easily from the impedance information output controller 70 of the matching device. As a result, the parameters of the matching device can be set specifically for the heating subject, and the matching device can be simplified on the basis of the results.

### INDUSTRIAL APPLICABILITY

The semiconductor type high-frequency dielectric heating device according to the present invention, as well as being used favorably to thaw a frozen foodstuff or the like at high speed, can be applied widely as an industrial dielectric heating device, and can also be incorporated and used in a tabletop thawing device (a microwave), a freezer, or the like for household or professional use, and so on. Hence, the semiconductor type high-frequency dielectric heating device according to the present invention is highly industrially applicable.

1. A high-frequency dielectric heating device comprising a high-frequency power supply, a pair of electrodes disposed opposite each other, reflected power detector connected between the electrodes and the high-frequency power supply and detects reflected power generated when a heating subject is heated, and an impedance matching device that adjusts the reflected power,
wherein the matching device includes a capacitor connected in parallel to the high-frequency power supply, and at least one of a capacitor and a coil connected in series to the electrodes, at least a reactance of the capacitor or the coil being adjustable, and
the high-frequency power supply is configured to have a variable frequency.

2. The high-frequency dielectric heating device according to claim 1, wherein the high-frequency power supply is a semiconductor type high-frequency power supply.

3. The high-frequency dielectric heating device according to claim 1, wherein the matching device includes varier that implements either multistep switching or continuous variation on a capacitance of at least one of the capacitor connected in parallel to the high-frequency power supply and the capacitor connected in series to the electrodes.

4. The high-frequency dielectric heating device according to claim 1, wherein the matching device includes a capacitor connected in parallel to the electrodes.

5. A high-frequency dielectric heating device comprising a semiconductor type high-frequency power supply, a pair of electrodes disposed opposite each other, and an impedance matching device,
wherein the matching device includes a first capacitor connected in parallel to the high-frequency power supply, a third capacitor connected in parallel to the electrodes, and a coil and a second capacitor connected in series between the first capacitor and the third capacitor.

6. The high-frequency dielectric heating device according to claim 5, wherein at least one of the first capacitor and the second capacitor includes capacitance varier.

7. The high-frequency dielectric heating device according to claim 5, wherein, in an impedance matching range formed by an output impedance of the high-frequency power supply and the matching device, a resistance of the matching range includes a part that is larger than the output impedance, and a reactance range is set to be larger on a negative side than on a positive side.

8. The high-frequency dielectric heating device according to claim 1, further comprising an impedance information output controller that outputs impedance information relating to the matching device to the high-frequency dielectric heating device.

9. The high-frequency dielectric heating device according to claim 5, further comprising an impedance information output controller that outputs impedance information relating to the matching device to the high-frequency dielectric heating device.
